(19) United States
(12) Patent Application Publication
(10) Pub. No.: US 2014/0250403 A1
(43) Pub. Date: Sep. 4, 2014

(54) VIRTUAL KEYBOARD INTERFACE SYSTEM AND ELECTRONIC APPARATUS USING SAME

(71) Applicant: HON HAI PRECISION INDUSTRY CO., LTD., New Taipei (TW)

(72) Inventors: MING-HUNG CHUNG, New Taipei (TW); CHIA-CHING HSU, New Taipei (TW); JIAN-SHIHN TSANG, New Taipei (TW)

(73) Assignee: HON HAI PRECISION INDUSTRY CO., LTD., New Taipei (TW)

(21) Appl. No.: 14/192,975

(22) Filed: Feb. 28, 2014

(30) Foreign Application Priority Data
Mar. 1, 2013 (TW) 102107149

(51) Int. Cl. G06F 3/0488

(52) U.S. Cl. CPC G06F 3/04886
USPC 715/773

(57) ABSTRACT

A virtual keyboard interface system of an electronic apparatus for displaying a virtual keyboard interface in a display of the electronic apparatus includes a graphical data module and a displaying module. The graphical data module stores graphical data of a number of keys, a number of shadow parts corresponding to the keys, and a number of patterns on the keys. The displaying module displays the virtual keyboard interface on the display according to the graphical data to make the virtual keyboard interface being seen from a slanting angle α relative to a vertical direction.

### BACKGROUND

1. Technical Field

The present disclosure relates to graphical interface systems, and particularly to a virtual keyboard interface system.

2. Description of Related Art

Generally, data is input to an electronic apparatus with a touch screen via a virtual keyboard interface. However, the virtual keyboard interface of the current electronic apparatus is planar, which lacks stereoscopic impression similar to a physical keyboard.

Therefore, it is desirable to provide a means to overcome the above-mentioned problems.

### BRIEF DESCRIPTION OF THE DRAWINGS

Many aspects of the embodiments can be better understood with references to the following drawing. The components in the drawing are not necessarily drawn to scale, the emphasis instead being placed upon clearly illustrating the principles of the embodiments.

FIG. 1 is a block diagram of one embodiment of an electronic apparatus including a virtual keyboard interface system for displaying a virtual keyboard interface.

FIG. 2 is an isometric view of the virtual keyboard interface.

FIG. 3 is an isometric view of an input box displayed by the electronic apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of and “a number of mean “at least two.”

Embodiments of the disclosure are described with reference to the drawing.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage unit. Some non-limiting examples of non-transitory computer-readable median include CDs, DVDs, BLU-RAY, flash memory, and hard disk drives.

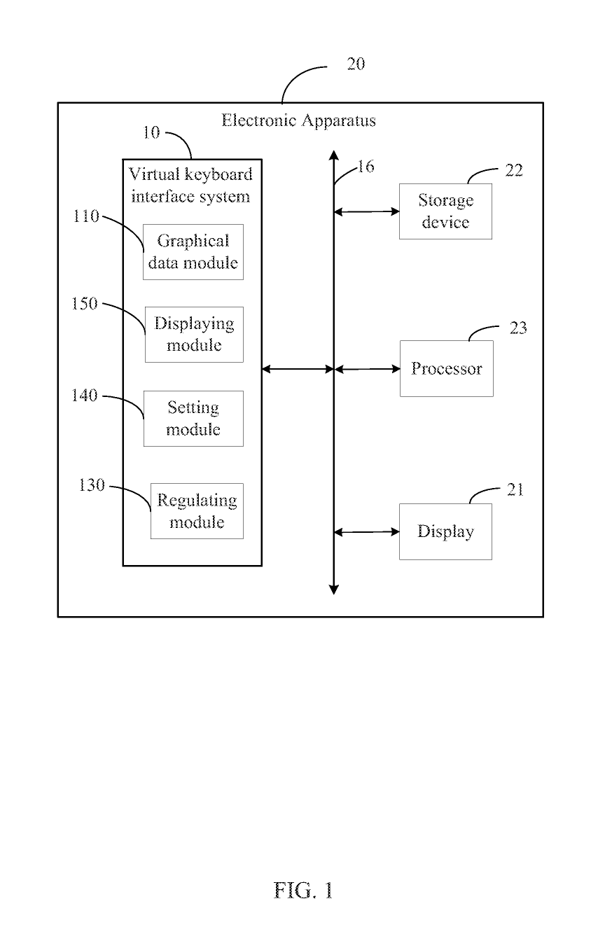

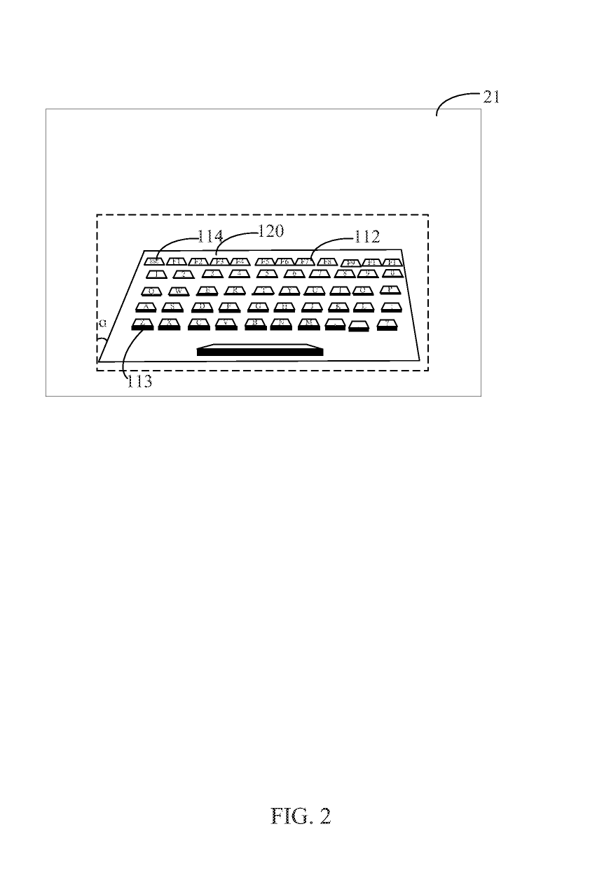

FIG. 1 shows a block diagram of one embodiment of an electronic apparatus 20 including a virtual keyboard interface system 10. FIG. 2 shows a virtual keyboard interface 120 of the electronic apparatus 20. The virtual keyboard interface 120 is displayed as being seen from a slanting angle α relative to a vertical direction to imitate stereoscopic effect of a physical keyboard. The electronic apparatus 20 includes a display 21, a storage device 22, and a processor 23. The virtual keyboard interface system 10 is used to display a virtual keyboard interface 120 on the display 21. Computerized codes of the virtual keyboard system 10 is stored in the storage device 22 and executed by the processor 30. The display 21, the storage device 22, the processor 23, and the virtual keyboard system 10 are directly or indirectly electrically connected via a bus 24 for exchange of data or control signals. The electronic apparatus 20 may be, but is not limited to, a smart phone, a tablet computer, or an intelligent television.

The virtual keyboard system 10 includes a graphical data module 110, a setting module 140, a regulating module 130, and a displaying module 150. Computerized codes of these modules 110, 140, 130, and 150 of the virtual keyboard system 10 may be embedded in an operating system of the electronic apparatus 20, or stored in the storage device 22 and executed by the processor 23.

The graphical data module 110 stores graphical data of a number of keys 112, a number of shadow parts 113 corresponding to the keys, and a number of patterns 114 on the keys 112 in an assigned area of the storage device 22. Each of the shadow parts is a dark area displayed below each key 112 to strengthen the stereoscopic impression of the key 112. In detail, the graphical data includes different sizes and shapes of the keys 112, different sizes and shapes of the shadow parts 113, and different positions of the keys 112 and the shadow parts 113 on the virtual keyboard interface 120. The patterns 114 may be, but are not limited to, characters, symbols, or figures.

The displaying module 150 displays the virtual keyboard interface 120 on the display 21 according to the graphical data and the slanting angle α of the virtual keyboard interface 120. The displaying module 150 displays each of the keys 112 as a trapezoid shape with a narrow top and a wide bottom. The displaying module 150 displays each of the shadow parts 113 at a bottom of the corresponding keys 112. Areas of the shadow parts 113 in the same virtual keyboard interface 120 are gradually decreased along a direction from a bottom of the virtual keyboard interface 120 to a top of the virtual keyboard interface 120.

The graphical data includes an original area R1 of each key 113 and an original height H1 of each pattern 114 defined as the slanting angle α is zero. A display area R2 of each key 113 and a display height H2 of each pattern 114 are changed according to the slanting angle α of the virtual keyboard interface 120. A relation between the display area R2 and the original area R1 follows a first equation of R2/R1=1/cos α. A relation between the display height H2 and the original height H1 follows a second equation of H2/H1=1/cos α.

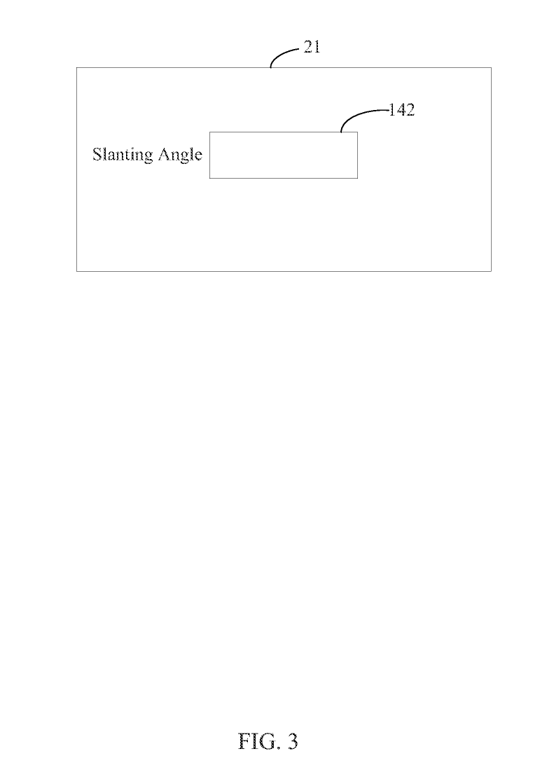

Referring to FIG. 3, the setting module 140 transmits a regulating signal to the regulating module 130 when a user changes the slanting angle α of the virtual keyboard interface 102. The setting module 140 displays an input box 142 on the display 21 according to actions of the user, such as pressing of a button (not shown) of the electronic apparatus or touching an assigned position on the display 21. The user inputs a new slanting angle α in the input box 142. The setting module 140 generates the regulating signal having the new slanting angle α and transmits the regulating signal to the regulating module 130.

The regulating module 130 controls the displaying module 150 to display the virtual keyboard interface 120 seen from the new slanting angle α relative to the vertical direction. The regulating module 130 receives the regulating signal from the setting module 140 and calculates new display areas R2 of the keys 113 corresponding to the new slanting angle α and new display heights H2 of each patterns 114 corresponding to the new slanting angle α. The regulating module 130 transmits a controlling signal having the new display areas R2 of the keys 113 and the new display heights H2 of the patterns 114 corresponding to the new slanting angle α to the displaying module 130 and controls the displaying module 130 to display the keys 113 with the new display areas R2 and the patterns 114 with the new display heights H2.

While various exemplary and preferred embodiments have been described, it is to be understood that the present disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A virtual keyboard interface system of an electronic apparatus for displaying a virtual keyboard interface on a display of the electronic apparatus, comprising:
a graphical data module that stores graphical data of a plurality of keys, a plurality of shadow parts corresponding to the keys, and a plurality of patterns on the keys; and
a displaying module that displays the virtual keyboard interface on the display according to the graphical data to make the virtual keyboard interface being seen from a slanting angle α relative to a vertical direction.

2. The virtual keyboard interface system of claim 1, wherein each of the keys is displayed as a trapezoid shape with a narrow top and a wide bottom.

3. The virtual keyboard interface system of claim 2, wherein the graphical data comprises sizes and shapes of the keys, sizes and shapes of the shadow parts, and positions of the keys and the shadow parts on the virtual keyboard interface.

4. The virtual keyboard interface system of claim 3, wherein the displaying module displays the shadow parts at a bottom of the corresponding keys.

5. The virtual keyboard interface system of claim 4, wherein area of each shadow part in the same virtual keyboard interface are gradually decreased from a direction from a bottom of the virtual keyboard interface to a top of the virtual keyboard interface.

6. The virtual keyboard interface system of claim 3, wherein the graphical data comprises an original area R1 of each key defined as the slanting angle α is zero, a display area R2 of each key is changed according to the slanting angle a, and a relation between the display area R2 of each key and the original area R1 follows a first equation of R2/R1=1/cos α.

7. The virtual keyboard interface system of claim 6, wherein the graphical data comprises an original area H1 of each pattern defined as the slanting angle α is zero, a display height H2 of each pattern is changed according to the slanting angle α, and a relation between the display height H2 of each pattern and the original height H1 follows a second equation of H1/H2=1/cos α.

8. The virtual keyboard interface system of claim 7, further comprising a setting module that sets a new slanting angle, wherein the setting module displays an input box to receive the new slanting angle input by a user and generates a regulating signal having the new slanting angle.

9. The virtual keyboard interface system of claim 8, further comprising further comprising a regulating module that controls the displaying module to displays the virtual keyboard interface seen from the new slanting angle relative to the vertical direction, wherein the regulating module receives the regulating signal from the setting module, calculates the display areas R2 of the keys according to the first equation and the display heights H2 of each patterns according to the second equation, and controls the displaying module to regulate display the keys with the new display areas R2 and the patterns with the new display heights H2.

10. An electronic apparatus, comprising:
a display;
at least one processor;
a storage device; and
a virtual keyboard interface system for displaying a virtual keyboard interface on the display, the virtual keyboard interface system received in the storage device and executed by the at least one processor, comprising:
a graphical data module that stores graphical data of a plurality of keys, a plurality of shadow parts corresponding to the keys, and a plurality of patterns on the keys in an assigned area of the storage device; and
a displaying module that displays the virtual keyboard interface on the display according to the graphical data to make the virtual keyboard interface being seen from a slanting angle α relative to a vertical direction.

11. The electronic apparatus of claim 10, wherein each of the keys is displayed as a trapezoid shape with a narrow top and a wide bottom.

12. The electronic apparatus of claim 11, wherein the graphical data comprises sizes and shapes of the keys, sizes and shapes of the shadow parts, and positions of the keys and the shadow parts on the virtual keyboard interface.

13. The electronic apparatus of claim 12, wherein the displaying module displays the shadow parts at a bottom of the corresponding keys.

14. The electronic apparatus of claim 13, wherein area of each shadow part in the same virtual keyboard interface are gradually decreased from a direction from a bottom of the virtual keyboard interface to a top of the virtual keyboard interface.

15. The electronic apparatus of claim 12, wherein the graphical data comprises an original area R1 of each key defined as the slanting angle α is zero, a display area R2 of each key is changed according to the slanting angle α , and a relation between the display area R2 of each key and the original area R1 follows a first equation of R2/R1=1/cos α.

16. The electronic apparatus of claim 15, wherein the graphical data comprises an original area H1 of each pattern defined as the slanting angle α is zero, a display height H2 of each pattern is changed according to the slanting angle α, and a relation between the display height H2 of each pattern and the original height H1 follows a second equation of H1/H2=1/cos α.

17. The electronic apparatus of claim 16, further comprising a setting module that sets a new slanting angle, wherein the setting module displays an input box to receive the new slanting angle input by a user and generates a regulating signal having the new slanting angle.

18. The electronic apparatus of claim 17, further comprising further comprising a regulating module that controls the displaying module to displays the virtual keyboard interface seen from the new slanting angle relative to the vertical direction, wherein the regulating module receives the regulating signal from the setting module, calculates the display areas R2 of the keys according to the first equation and the display heights H2 of each patterns according to the second equation, and controls the displaying module to regulate display the keys with the new display areas R2 and the patterns with the new display heights H2.
